(19) United States
(12) Patent Application Publication
(10) Pub. No.: US 2023/0294075 A1
(43) Pub. Date: Sep. 21, 2023

(54) BIOMASS DEGRADATION PROCESSES USING A TIO2-BASED PHOTOCATALYST LEADING TO ACTIVATED BIOMASS

(71) Applicants: CY CERGY PARIS UNIVERSITÉ, CERGY (FR); ECOLE NATIONALE SUPERIEURE DE TECHNIQUES AVANCEES, Palaiseau (FR); COMMISSARIAT A L' ENERGIE ATOMIQUE AUX ENERGIES ALTERNATIVES, Paris (FR); CENTRE NATIONAL DE LA RECHERCHE SCIENTIFIQUE, Paris (FR)

(72) Inventors: Nicolas PASTERNAK, Avernes (FR); Nancy LINDER, Neuville sur Oise (FR); Laura-Line RISAL, Villebon-sur-Yvette (FR); Johnny DESCHAMPS, Orsay (FR)

(73) Assignees: CY CERGY PARIS UNIVERSITÉ, CERGY (FR); ECOLE NATIONALE SUPERIEURE DE TECHNIQUES AVANCEES, Palaiseau (FR); COMMISSARIAT A L' ENERGIE ATOMIQUE AUX ENERGIES ALTERNATIVES, Paris (FR); CENTRE NATIONAL DE LA RECHERCHE SCIENTIFIQUE, Paris (FR)

(21) Appl. No.: 18/013,972

(22) PCT Filed: Jun. 30, 2021
(86) PCT No.: PCT/EP2021/068014

§ 371 Date: Dec. 30, 2022

(30) Foreign Application Priority Data
Jun. 30, 2020 (EP) 20183320.9

(51) Int. Cl. B01J 21/06; B01J 23/30; B01J 35/00; B01J 37/04; B01J 37/03; C01B 3/02

(52) U.S. Cl. CPC B01J 21/063; B01J 23/30; B01J 35/004; B01J 37/04; B01J 37/031; C01B 3/02; C02F 1/30

(57) ABSTRACT

Process for the preparation of a TiO₂ photocatalyst/biomass carrier, with TiO₂/MₓO_{y} nanocrystals, of at least nanometric size and photocatalysis-active at least in visible light, consisting of the following steps:
a) preparation and heating of an aqueous solution of hydrochloric acid with a given pH, between 0 and 6, and at a temperature between 20° C. and 60° C., with no surfactant,
b) addition to the acidic aqueous solution of the titanium oxide precursor, or the mixture of a TiO₂ titanium oxide precursor and at least one other precursor of another MₓO_{y} oxide, consisting, 80% to 100%, of TiO₂ moles and 0% to 20% of moles of another metal or semi-metal MₓO_{y} oxide, a precipitate then forming, and stirring of the acidic aqueous reaction medium obtained, so as to dissolve the precipitate;
c) an immersing step of the carrier in the acidic aqueous reaction medium,
d) a heating step of the acidic aqueous reaction medium, the carrier for crystallizing the titanium oxide precursors, or the mixture of the titanium oxide precursor and at least one other precursor of the other metal or semi-metal oxide,
e) a possible water rinse step and a biomass carrier recovery step with TiO₂/MₓO_{y} nanocrystals, bound by covalent bonds to the biomass carrier.

The invention relates to the technical field of photocatalysis.

Photocatalysis is an oxidation process enabling the production of oxidizing species, in particular radicals, by radiation at wavelengths corresponding to energies greater than that of the energy band gap of certain semiconductor solids, in the presence of water and dioxygen.

Photocatalysis involves a photocatalyst, which is a catalyst activated by light energy with water and air oxygen that are the oxidizers. The photocatalyst helps accelerate the speed of a chemical reaction, without being consumed in the end. It is usually a semiconductor belonging to oxide (TiO₂, ZnO) or sulfide (CdS, ZnS) chalcogenides.

Photocatalysis is currently used on an industrial scale in the production of active surfaces, self-cleaning coatings and materials, self-disinfecting agents, or purifying agents.

Photocatalysis is also proposed in water treatment. Other potential applications exist, such as surface functionalization (surface agent) or hydrogen production. A review of the proposed processes for photocatalytic production of hydrogen from biomass was presented in 2016 by “Puga, Photocatalytic production of hydrogen from biomass-derived feedstocks”, Coordination Chemistry Reviews 315, pages 1-66, 2016. A short review of the proposed processes for photocatalytic hydrogen production from lignocellulosic products (including wood, sawdust, grass, bagasse, algae) was presented in 2018 by Kuehnel, “Solar hydrogen generation from lignocellulose”, Angew Chem Int 57, 2018, pages 3290-3296.

The invention relates more specifically to heterogeneous photocatalysis, the photocatalyst being in solid phase and the reagents being in gas or aqueous phase.

Whether in the gaseous or aqueous phase, heterogeneous photocatalysis consists of five steps: migration of the reactive molecules dispersed in the fluid to the surface of the catalyst; adsorption of the reactive molecules on the surface of the catalyst; reaction on the surface of the adsorbed phase; desorption of the reaction products; separation of the products from the fluid/catalyst interface.

The photocatalytic reaction is based on photocatalyst absorption of photons of energy greater than or equal to its energy band gap.

The most commonly used photocatalyst to date is titanium dioxide (TiO₂).

There are eleven crystalline structures for titanium dioxide, seven of which are stable at room temperature and pressure. In nature, titanium dioxide is present mainly in the form of anatase and rutile, and more rarely in the form of brookite or TiO₂(B).

Titanium dioxide is most often synthesized as anatase, or as rutile, and much more rarely as brookite. There are other forms that are more difficult to synthesize, as well as different TiO₂₋ₓ suboxides, or TiO₂₊ₓsuperoxides. Titanium dioxide can be synthesized physically, for example by cathode sputtering, or by various chemical synthesis processes, for example by pyrolysis, electrochemical anodization, hydrothermal synthesis, thermal hydrolysis, sol-gel process, or by microemulsions, micelles or reverse micelles.

The reference photocatalytic material in most laboratory studies is marketed by Evonik-Degussa as Aeroxide TiOP25 (formerly Degussa P25). This product consists of a mixture of approximately 80% anatase and 20% rutile for crystallized phases and a low fraction of TiO in amorphous form. The exact structure of this Aeroxide product is discussed, see for example Jiang et al, “Anatase and rutile in evonik aeroxide P25: heterojunctioned or individual nanoparticles?”, Catalysis today, Vol 300, February 2018, pages 12-17. For a quantitative characterization of this Evonik Aeroxide P25 product, we can refer, for example, to the document Tobaldi et al, “Fully quantitative X-ray characterisation of Evonik Aeroxide TiO₂ P25” ‘Materials Letters, May 2014, Vol 122, 345-347.

Anatase has an energy band gap width of 3.23 eV. Anatase activity is therefore limited to wavelengths shorter than the energy band gap width, i.e. λ<387 nm. Rutile has an energy band gap width of 3.02 eV. Rutile activity is therefore limited to wavelengths shorter than the energy band gap width, i.e. λ<411 nm. These gap values can be slightly modulated depending on the size of the material, by quantum-confined Stark effect, or by doping with metal ions or nanoparticles.

In its most common commercial forms, TiO₂ is therefore mainly activated by ultraviolet light, the rutile also absorbs a small part of the visible spectrum. The wavelength ranges useful for rutile and anatase correspond only to about 6% of the solar radiation received on Earth, compared to about 50% for the visible range.

Numerous works have been done to expand the effectiveness of titanium dioxide in visible light.

In a first approach, a black titanium dioxide was obtained. These materials discovered in 2011 would have an energy band gap width of 1.54 eV, enabling photocatalysis in near infrared. A review of the processes considered is presented in the document Ullattil et al, “Black TiO₂ nanomaterials: a review of recent advances”, Chemical Engineering Journal 343 (2018), pages 708-736. Another review of black titanium dioxide synthesis processes is presented in 2020 by Rajaraman et al, Black “TiO₂: a review of its properties and conflicting trends”, Chemical Engineering Journal Vol 389, 2020. The processes to be implemented for the production of black titanium dioxide are complex and energy-intensive, including high pressure and high temperature hydrogenation, plasma processing, ion implantation.

In a second approach, titanium dioxide is doped. A review of the main dopants used was presented in 2019 by Kumaravel et al, “Photocatalytic hydrogen production using metal doped TiO₂: a review of recent advances”, Applied Catalysis B: Environmental vol 244, 2019, pages 1021-1064. According to this review, the most studied TiO₂ dopants to increase hydrogen production by photocatalysis are nitrogen, copper, gold and platinum, as well as nickel, palladium, titanium, and bismuth, with other dopants more rarely offered (beryllium, magnesium, strontium, barium, niobium, chromium, manganese, iron, ruthenium, cobalt, rhenium, silver, boron, indium, carbon, tin, sulfur, fluorine, chlorine, bromine, neodymium, europium). In most of the tests mentioned in this review, the light source is a xenon lamp or ultraviolet source. Doping titanium dioxide causes significant costs, especially when the dopant is a noble metal, or lanthanide.

In a third approach, titanium dioxide is sensitized. Three types of sensitization can be identified: heterojunction with a semiconductor, plasmonic effect, and contact with a conjugated compound.

For heterojunction with a semiconductor, the most commonly used materials are oxides ZnO, NiO, Cu₂O, SnO₂, RuO₂, ZrO₂, Bi₂O₃, WO₃, Fe₂O₃, V₂O₅, Ag₃PO₄, and also CdS, Ag₂S, MoS₂, Bi₂S₃, CdSe, AgCl, AgBr, AgI, C₃N₄.

For the plasmonic effect, the anatase structure is associated with nanoparticles of noble metal, such as: gold, silver, palladium, or platinum.

Sensitization by a conjugate compound, called dye sensitization, uses transition metal complexes such as ruthenium, or iron, or graphitic carbon, or graphene, aromatic compounds such as polythiophene, polyaniline, or polyvinyl alcohol polymers. These conjugated compounds are most often bound to titanium dioxide by covalent bonds, but can also be bound by hydrogen bonds, electrostatic interactions, or van der Waals forces.

The sensitization of titanium dioxide incurs significant costs, especially when the semiconductor used is made of noble metal, or when a noble metal such as gold, palladium or platinum is used to achieve a plasmonic effect. Sensitization by a conjugated compound also incurs high costs and requires some know-how, particularly for the manufacture of graphene. Photocatalysis using titanium dioxide is widely proposed in effluent treatment, including water treatment.

Given the potential health risks of titanium dioxide in its nanometric form, various techniques have been proposed to hold titanium dioxide on a carrier, or to ensure the recycling of titanium dioxide. Separation of fine titanium dioxide particles by ultrafiltration results in very high costs. Various carriers have been proposed for the binding of titanium dioxide TiO₂ already synthesized in advance: glass, ceramic, clay mineral (such as for example, sepiolite, attapulgite, vermiculite), zeolite, metal plate, cellulose acetate, titanium foam, diatomite, activated charcoal, carbon nanotubes, graphene, fullerene. Binding can be performed by a variety of methods, including anodization, sol-gel process or sputtering.

A review of the binding processes of TiO₂ on clay substrate was presented in 2018 by Mishra et al, “Clay supported TiO₂ nanoparticles for photocatalytic degradation of environmental pollutants: a review”, Journal of Environmental Chemical Engineering, vol 6, issue 5, 2018, pages 6088-6107.

The binding of TiO₂ to activated carbon is conventionally proposed in conjunction with the manufacture of activated carbon from biomass, in particular from lignocellulosic by-products of the agricultural and agri-food sectors. TiO₂ particles can be bound to activated carbon by sol-gel process, vapor deposition, or by impregnation of activated carbon with TiO₂ nanoparticle suspensions.

One of the major disadvantages of binding titanium dioxide to a carrier is the sharp reduction in photocatalytic activity, compared to dispersed TiO₂.

Binding of TiO₂ titanium dioxide to plant substrates has been proposed, including cotton fibers, tea leaves, fern leaf, kapok fibers, bamboo fibers. In most proposed processes, the plant substrate serves as a carrier (bio-template) and TiO₂ particles are obtained by calcination, pyrolysis, or heat treatment transforming the plant substrate into carbon.

The document Djellabi et al. “Sustainable and easy recoverable magnetic TiO₂ lignocellulosic biomass@Fe₃O₄ for solar photocatalytic water remediation, Journal of Cleaner Production” July 2019, 233, p. 841-847, indicates that hybridization of TiO₂ titanium dioxide with lignocellulosic biomass, reduces the energy band gap of titanium dioxide by developing Ti—O—C bonds, enabling photocatalytic activity to be obtained for radiation in visible light (300 W xenon lamp with UV filter). In this document, a sol-gel synthesis process assisted by ultrasound at 500° C. is used, which is very energy intensive. In addition, such a synthesis temperature can be aggressive for biomass and cause it to break down. The DRX structural analysis shows no trace of cellulose, which should appear towards 2 theta equal to 22 degrees.

The document Xue et al, “Visible light-assisted efficient degradation of dye pollutants with biomass-supported TiO₂ hybrids”, Materials Science & Engineering C 82, pages 197-203, 2018, describes the binding of TiO₂ particles to sugar bagasse, composed of cellulose, hemicellulose and lignin, this binding being presented as increasing the photocatalytic properties of TiO₂ in visible light (500 W halogen lamp with UV filter). In this document, the synthesis is based on a complex, long and energy-intensive process based on a dialysis technique followed by a calcination between 100° C. and 400° C. of the biomass TiO₂ composite material obtained. Structural material characterizations (DRX) clearly show that above 200° C., calcination leads to biomass breakdown.

Invention

A first object of the invention is to propose a biomass degradation process by photocatalysis, the photocatalyst being based on titanium dioxide, the process using natural light, without risk of dissemination of titanium dioxide in the environment.

A second object of the invention is to propose a biomass degradation process by photocatalysis, the photocatalyst being based on titanium dioxide, the process enabling, among other things, the production of usable decomposition products, in particular alcohol type (isopropanol, methanol, ethanol, glycerol) or other (in particular acetone, acetic acid).

A third object of the invention is to propose a biomass degradation process by photocatalysis, the photocatalyst being based on titanium dioxide, the process enabling usage of algae, wastewater treatment plant sludge, by-products of the forestry industry such as sawdust, or products of the agri-food industry such as sorbitol, or glucose.

Another object of the invention is to propose a process meeting at least one of the above objects and enabling the degradation of the biomass in solid form or in aqueous solution.

Another object of the invention is to propose a process meeting at least one of the above objects, the process being integrated in-situ, all the steps of the process being able to be carried out at a single site.

Another object of the invention is to propose a process meeting at least one of the above objects, the process not using solvent.

Another object of the invention is to propose a process meeting at least one of the above objects, the process using titanium dioxide sensitized with a metal oxide type MₓO_{y}.

For these purposes, the invention relates, according to a first aspect, to a process of preparation of a TiO₂ photocatalyst/biomass carrier with TiO₂/MₓO_{y} nanocrystals, at least nanometric in size and photocatalysis-active at least in visible light (and therefore active in UV or other radiation), comprising the following substeps:
a) preparation and heating of an aqueous solution of hydrochloric acid with a given pH, between 0 and 6, and at a temperature between 20° C. and 60° C., with no surfactant;
b) addition to the aqueous acid solution of a titanium oxide precursor, or a mixture of a titanium oxide TiO₂ precursor and at least one other precursor of another MₓO_{y} oxide, consisting, 80% to 100%, of TiO₂ moles and 0% to 20% of moles of another metal or semi-metal MₓO_{y} oxide, a precipitate then forming, and stirring of the acid aqueous reaction medium obtained, so as to dissolve the precipitate;
c) immersion of a biomass carrier in the acidic aqueous reaction medium to condense the precursors of the acidic aqueous reaction medium on its surface, or sputtering of the acidic aqueous reaction medium on the biomass carrier, the nanocrystals being created when the biomass carrier is put in contact with the acidic aqueous reaction medium (the process does not advantageously implement the so-called spin coating technique);
d) heating of the acidic aqueous reaction medium at a temperature between 30° C. and 90° C.;
   the biomass carrier for crystallizing the titanium oxide precursors, or the mixture of a titanium oxide precursor and at least one other precursor of the other metal or semi-metal oxide, directly on its surface, the nanocrystals being advantageously created directly on the surface of the biomass carrier;
e) a possible water rinse step and a biomass carrier recovery step with TiO₂/MₓO_{y} nanocrystals, bound (grafted) by covalent bonds to the biomass carrier.

The reaction medium heating step can have two substeps:
a first heating substep at a temperature between 30° C. and 60° C., for a given first duration;
a second heating substep at a temperature between 50° C. and 90° C., for a given second duration.

For example, for the first heating substep, the first given duration may be several hours. For example, for the second heating substep, the second given duration may be several hours.

According to various implementations, the titanium precursor is chosen from the group comprising titanium isopropoxide, Na₂Ti₃O₇ sodium titanate or a derivative.

According to various implementations, metal oxide is chosen from the group comprising SiO₂, ZrO₂, Al₂O₃, Fe₂O₃, CeO₂, MgO, CuO, NiO, Cu₂O, SnO₂, RuO₂, Bi₂O₃, WO₃, V₂O₅, Ag₃PO₄. Advantageously, the process steps are carried out in open air, without any co-solvent. Advantageously, the invention makes it possible to produce photocatalysis active carriers by incorporating titanium oxide-based materials under mild conditions (no surfactant, aqueous medium, requiring little energy, without excessive temperatures).

In certain implementations, in step a), the pH is chosen equal to 5, so as to obtain nanocrystals on the biomass carrier having a stable brookite crystalline form.

In other implementations, in step a), the pH is chosen between 0 and 2, so as to obtain nanocrystals on the biomass carrier having a rutile crystalline form.

In certain implementations, the first step a) of adding a titanium precursor is performed with the addition of a WO₃ metal oxide, the pH of the reaction medium being between 0 and 5.

In certain implementations, the heating step of the acidic aqueous reaction medium comprising the biomass carrier is carried out between 30° C. and 100° C.

In the present invention, the TiO₂ precursors are formed after a first formation of precipitate, which is vigorously agitated in order to dissolve it in the medium. Then, in this medium, the TiO₂ precursors bind to the carrier on its surface, on or inside, and crystallize only on the surface of the carrier in a single step. In other words, in the present invention, TiO₂ precursors crystallize and grow only after attaching to the carrier.

The acidic aqueous reaction medium can be stirred until disappearance of the precipitate.

In some implementations, the stirring of the acidic aqueous reaction medium is carried out between 800 rpm and 1,200 rpm.

The invention relates, according to a second aspect, to a biomass carrier with photocatalyst, that is photocatalysis-active at least in visible light (for example when a halogen lamp 500 W 8,550 lumen is used) and therefore is also active in UV or any other radiation.

The biomass carrier with photocatalyst is active at least in the visible light, i.e. with low energy supply. As a result, the carrier is also active to UV light that has greater energy; thus, the carrier is active in natural light.

The biomass carrier with photocatalyst is at least nanometric in size with TiO₂/MₓO_{y} nanocrystals bound (grafted) to its surface by covalent bonds, performed by the process as presented above, these nanocrystals consisting, 80% to 100%, of TiO₂ moles and 0% to 20% of moles of another MₓO_{y} metal or semi-metal oxide.

In certain implementations, the biomass carrier is chosen from the group comprising glucose, sorbitol, monocrystalline cellulose.

In other implementations, the biomass carrier is chosen from the group comprising algae, wood (in particular crushed pine).

Advantageously, the carrier is of micrometric, millimetric, centimetric size or greater.

The invention relates, according to another aspect, to a degradation process of TiO₂ photocatalysts/non-degraded biomass carrier with TiO₂/MₓO_{y} nanocrystals from a first biomass carrier created according to the process presented above, the degradation process comprising:
a step f) of photocatalytic degradation, at least in visible light, of the first biomass carrier with TiO₂/MₓO_{y} nanocrystals, to obtain a residue and decomposition products;
a step g) of treatment of the residue in an acidic aqueous solution, to obtain a recycled photocatalyst solution with TiO₂/MₓO_{y} nanoparticles reactive for the graft, forming a new acidic aqueous reaction medium;
   the reactive TiO₂/MₓO_{y} nanoparticles of the residue being created from the first biomass carrier with photocatalyst degraded into decomposition products;
a step h) adding a new biomass carrier to the recycled photocatalyst solution;
a step i) heating the new acidic aqueous reaction medium;
a drying step j), to form a new biomass carrier with TiO₂/MₓO_{y} nanoparticles bound (grafted) by covalent bond on the surface, the new biomass carrier with photocatalyst being photocatalysis-active at least in visible light.

Advantageously, the heating step i) is carried out at a temperature between 50 and 100° C. Advantageously, the new biomass carrier with TiO₂/MₓO_{y} nanoparticles from step j), undergoes and is degraded during a new step f), the biomass carrier degradation process being performed again in new steps g) to j) to obtain a new biomass carrier with TiO₂/MₓO_{y} nanoparticles from step j), which is degraded again in a new step f) and so on, the process operating following a cycle to recover the TiO₂/MₓO_{y} reactive nanoparticles of the residue that are reactive for the grafting, and which are bound (grafted) by covalent bonds to each new biomass carrier with photocatalyst added in the acidic aqueous reaction medium containing them.

Advantageously, step f) of photocatalytic degradation is carried out in natural light.

Advantageously, the photocatalytic degradation step is carried out by contact with air oxygen, at atmospheric pressure.

Advantageously, the photocatalytic degradation step is carried out under visible radiation (e.g., halogen lamp 500 W, light intensity 8,550 lumen), and even more particularly in natural light.

Advantageously, the decomposition products obtained are alcohol-type.

Advantageously, the decomposition products are chosen from the following list: acetone, isopropanol, methanol, glycerol, acetic acid, glyoxal, ethanol.

Advantageously, the degradation products include biogases such as hydrogen and/or methane.

Advantageously, the decomposition products are obtained without stirring the aqueous solution during step f).

The invention relates, according to another aspect, to reactive TiO₂/MₓO_{y} nanoparticles for grafting, and capable of bonding (grafting) by covalent bonds to a photocatalyst carrier to make it photocatalysis-active at least in visible light, resulting from the residue obtained by the degradation process presented above.

Other objects and advantages of the invention will be seen from the description of embodiments given below, with reference to the appended drawings, in which:

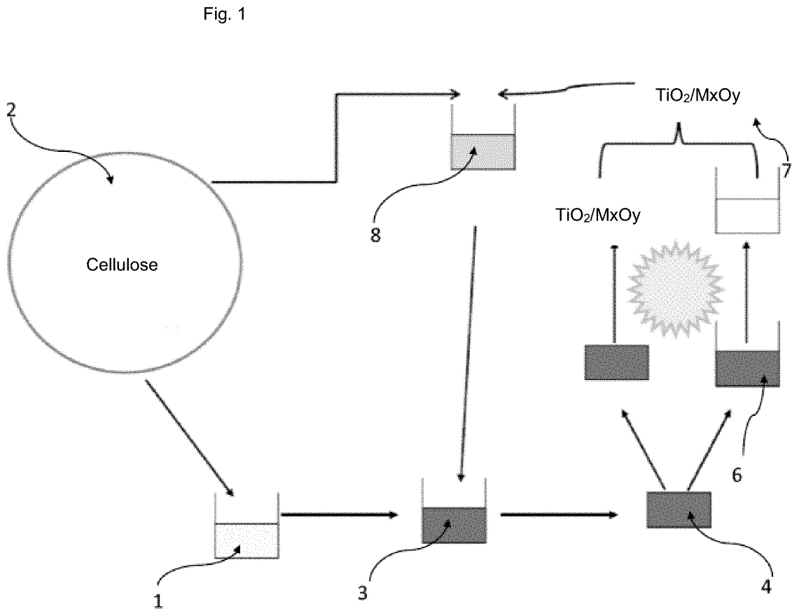

FIG. 1 is a diagram representing the steps of the biomass carrier degradation process by a TiO₂ catalyst, showing the recycling of the residue from the photocatalysis;

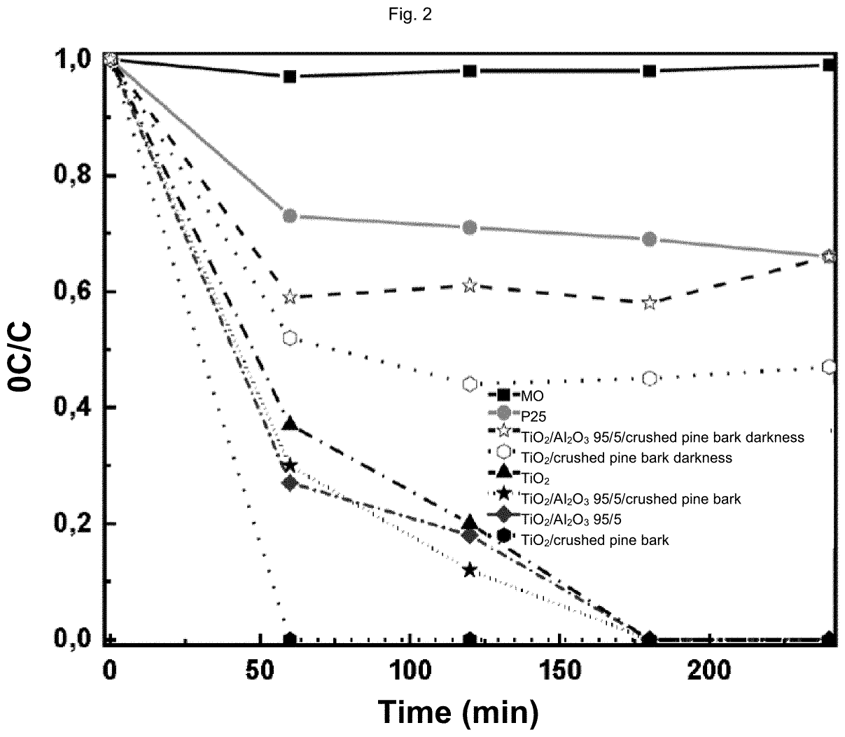

FIG. 2 is a diagram showing changes in methyl orange concentration by various reactive biomasses (TiO₂/pine, TiO₂/Al₂O₃/pine) compared to degradations obtained with commercial titanium dioxide (Aeroxide TiOP25), and degradations obtained with photocatalysts not supported by biomass (TiO₂/Al₂O₃), photocatalyst binding (TiO₂ or TiO₂/Al₂O₃) to biomass such as crushed pine increasing the degradation capacities of methyl orange;

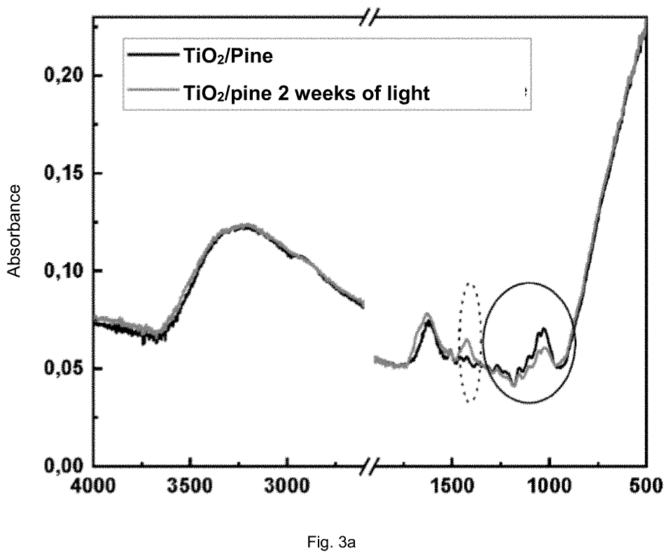

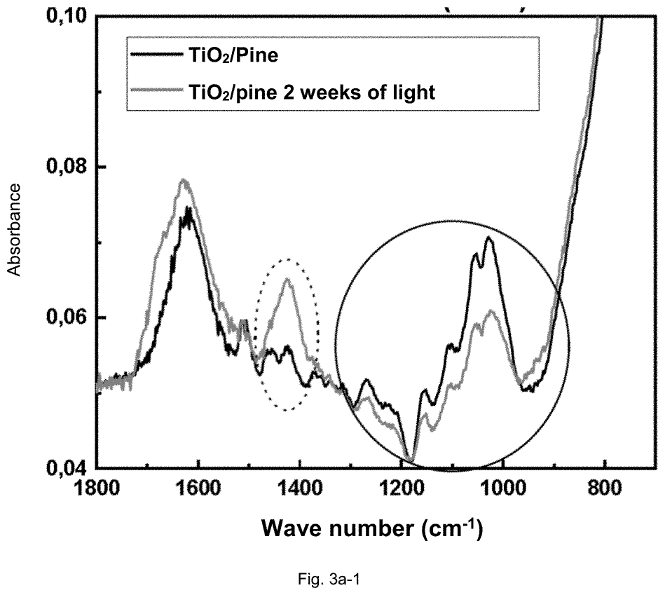

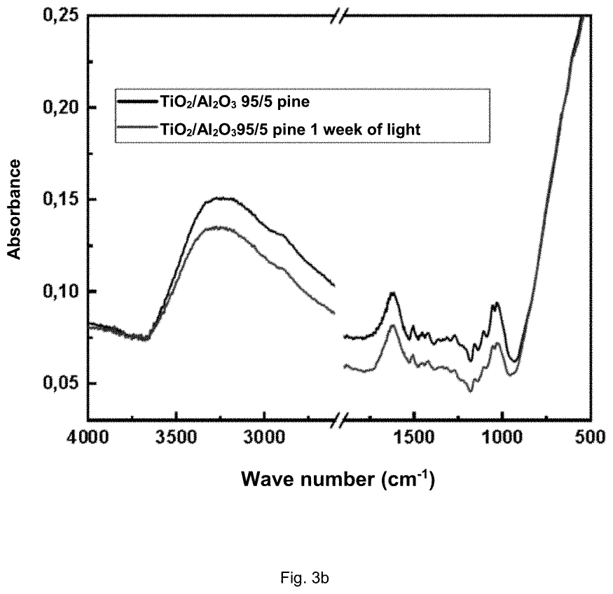

FIG. 3a represents the absorbance variations for activated biomass (TiO₂/Pine (crushed pine)) before and after two weeks of exposure to natural light;

FIG. 3a-1 represents an enlargement of FIG. 3a in the 1,800-800 cm⁻¹ region;

FIG. 3b represents the absorbance variations for activated biomass (TiO₂/Al₂O₃ 95/5 pine (crushed pine)) before and after one week of exposure to light;

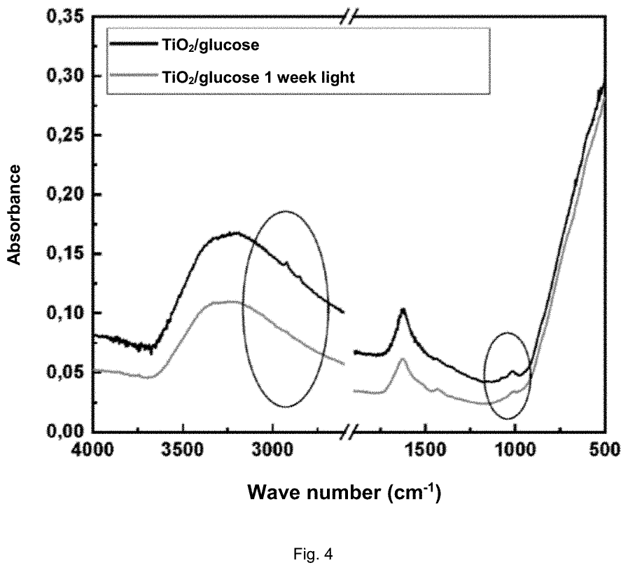

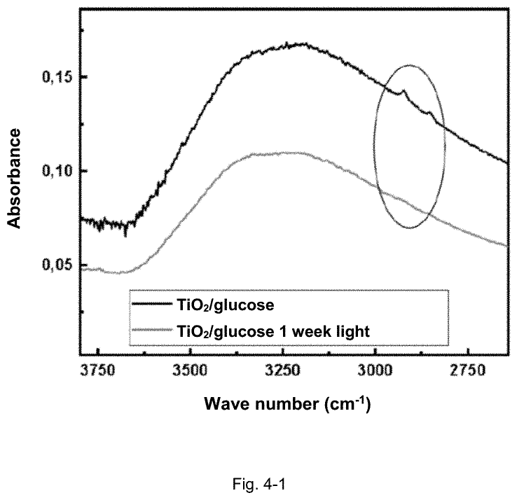

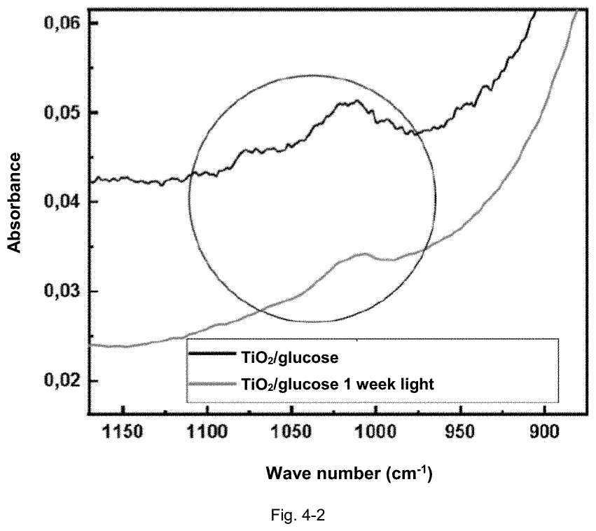

FIG. 4 represents the absorbance variations for activated glucose, before and after one week of exposure to natural light;

FIG. 4-1 and FIG. 4-2 represent the enlargements of FIG. 4 in the 3,750-2,750 cm⁻¹ and 1,150-900 cm⁻¹ regions, respectively;

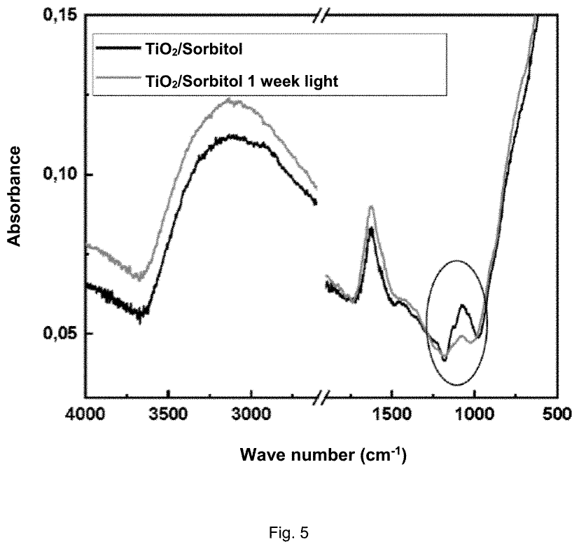

FIG. 5 represents the absorbance variations for sorbitol, before and after one week of exposure to natural light;

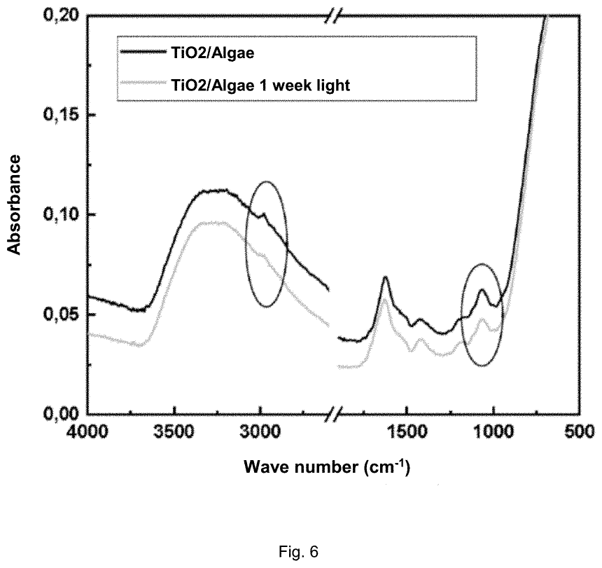

FIG. 6 represents the absorbance variations for activated biomass of brown algae (Pelvetia canaliculata), before and after one week of exposure to natural light;

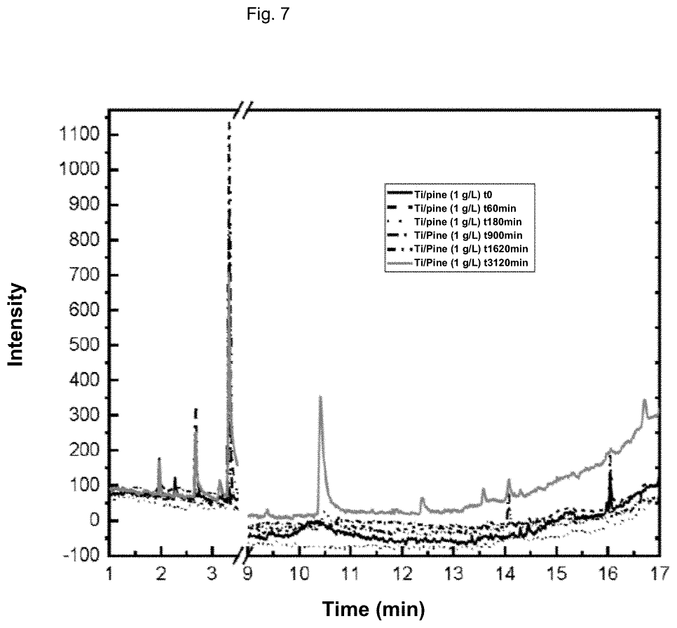

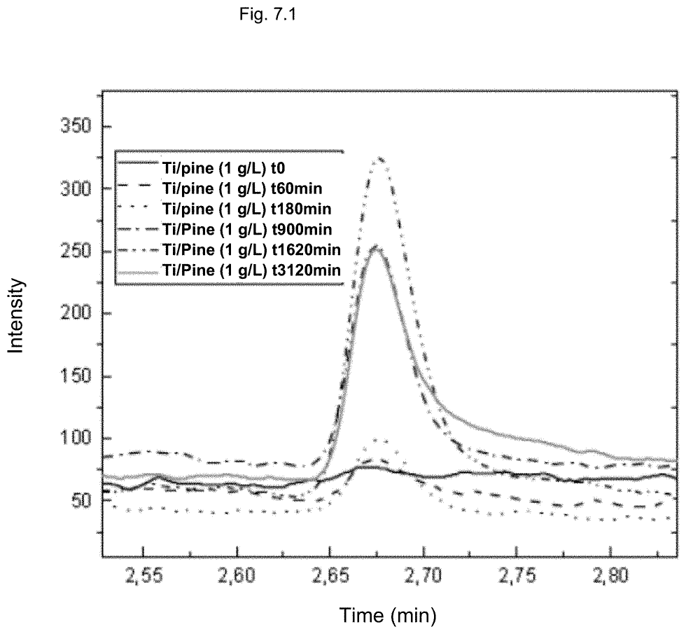

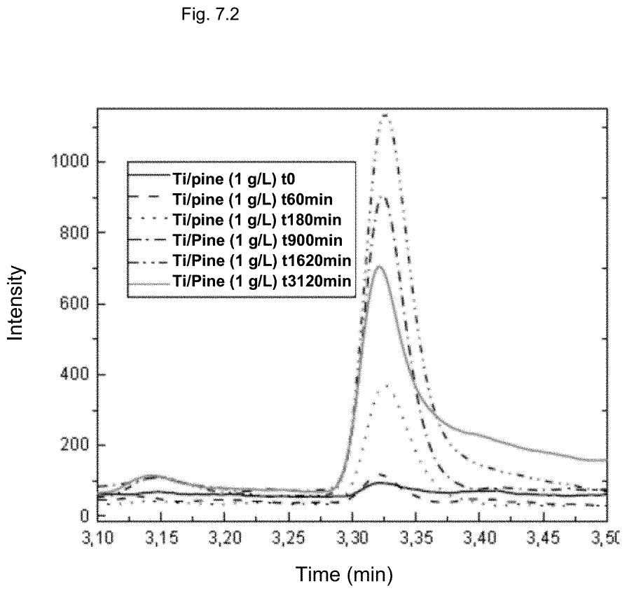

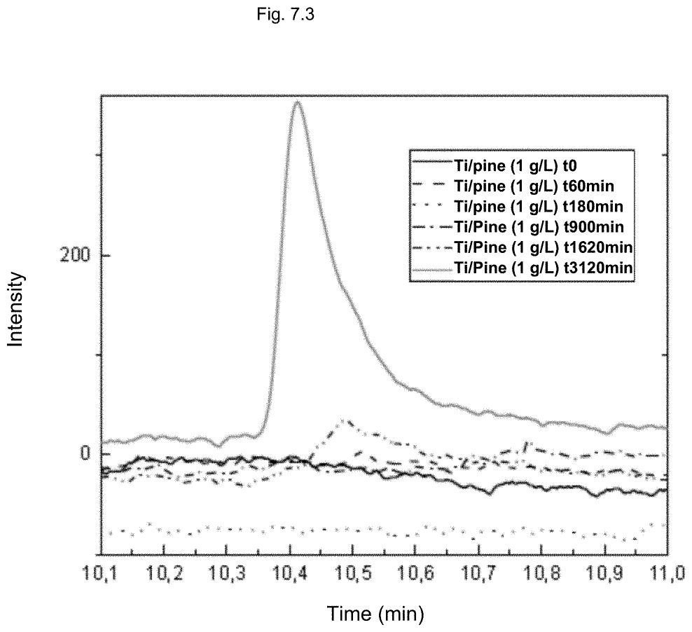

FIG. 7 represents the gas chromatography tracking data with flame ionization detector, during treatment of crushed pine biomass in aqueous solution, concentration of 1 g/L of activated biomass being dissolved and exposed to natural light;

FIGS. 7-1, 7-2, 7-3 represent the enlargements of FIG. 7 in the 2.55-2.80 min, 3.10-3.50 min, and 10.1-11 min regions, respectively;

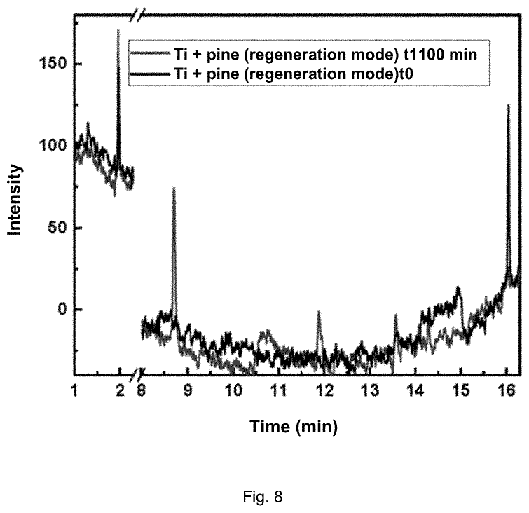

FIG. 8 represents the gas chromatography tracking data with flame ionization detector, during treatment of crushed pine activated biomass, the activated biomass supporting recycled titanium dioxide;

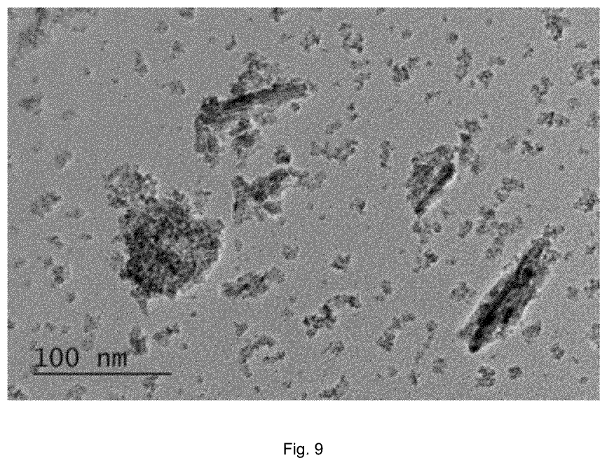

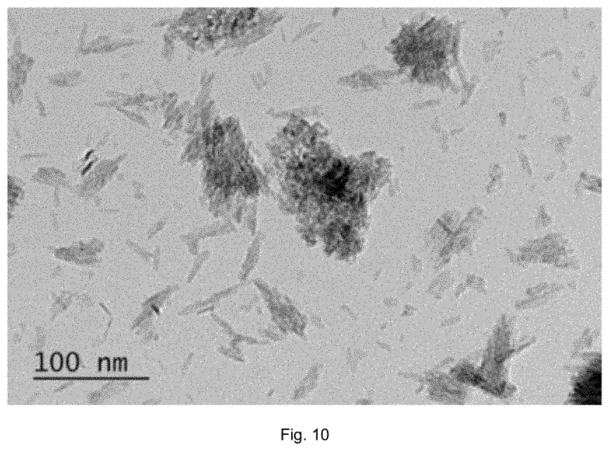

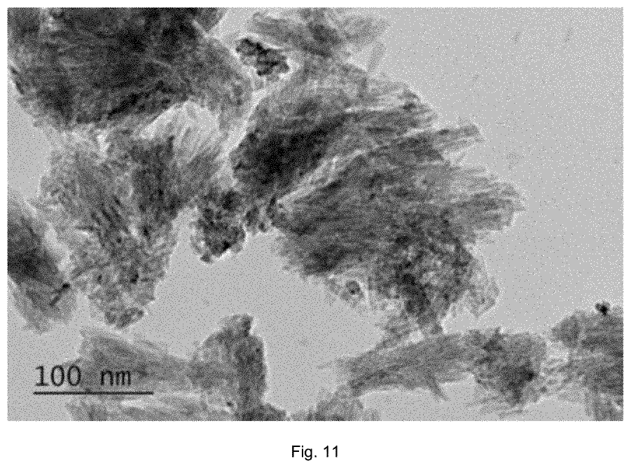

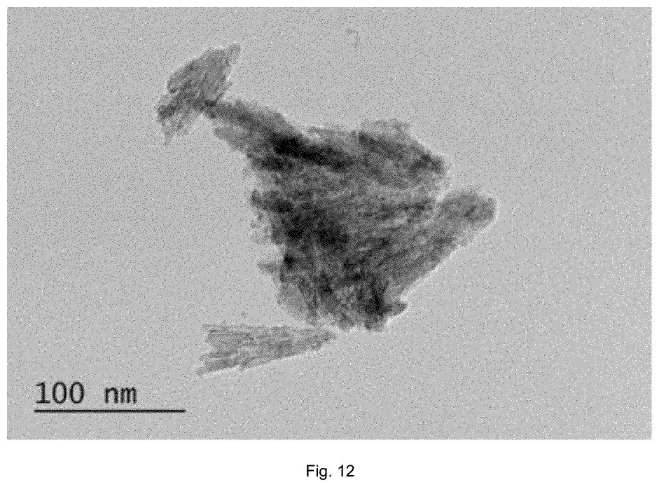

FIGS. 9 to 12 are electron microscopy images of composite materials transmission TiO₂/biomass according to the invention, FIG. 9 being a TiO₂/WO₃/crushed pine material, FIG. 10 a TiO₂/cellulose material, FIG. 11 a TiO₂/crushed pine material and FIG. 12 a TiO₂/glucose material;

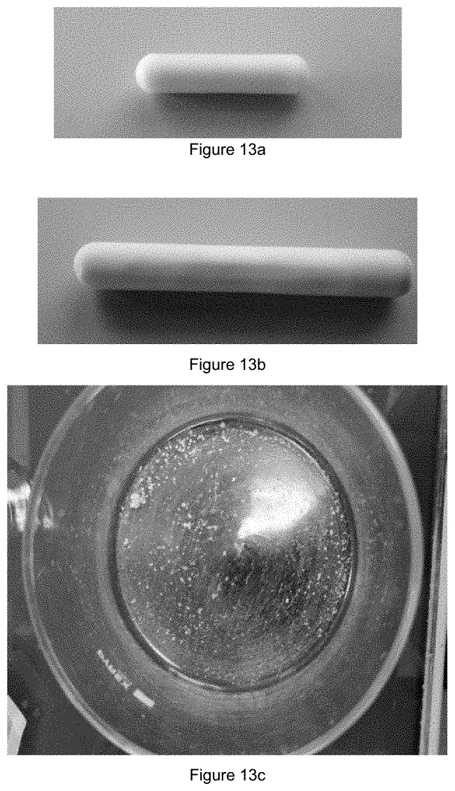

FIGS. 13a, 13b and 13c, respectively, are photographs of a Teflon stir bar (new PTFE, FIG. 13a), a stir bar after 78 hours of stirring in an aqueous solution of TiO₂/pine (FIG. 13b), [and] a beaker containing the supernatant isolated from the solution after 78 hours of radiation (FIG. 13c);

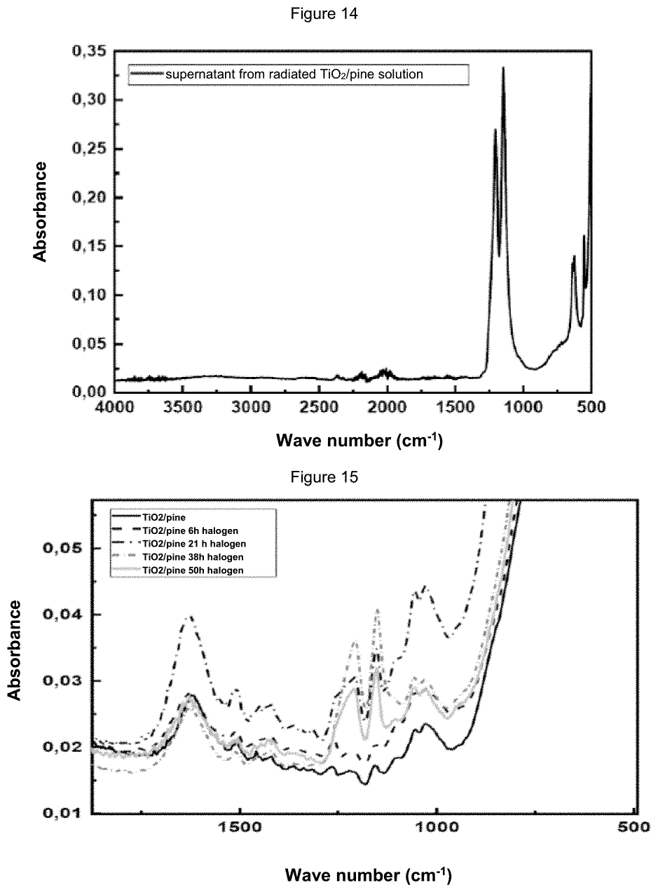

FIG. 14 represents the absorbance of the supernatant, perfectly corresponding with the absorbance of the PFTE;

FIG. 15 represents the monitoring of the degradation of the pine in the TiO₂/pine carrier by following the variations in absorbance, degradation of the Teflon after 21 hrs;

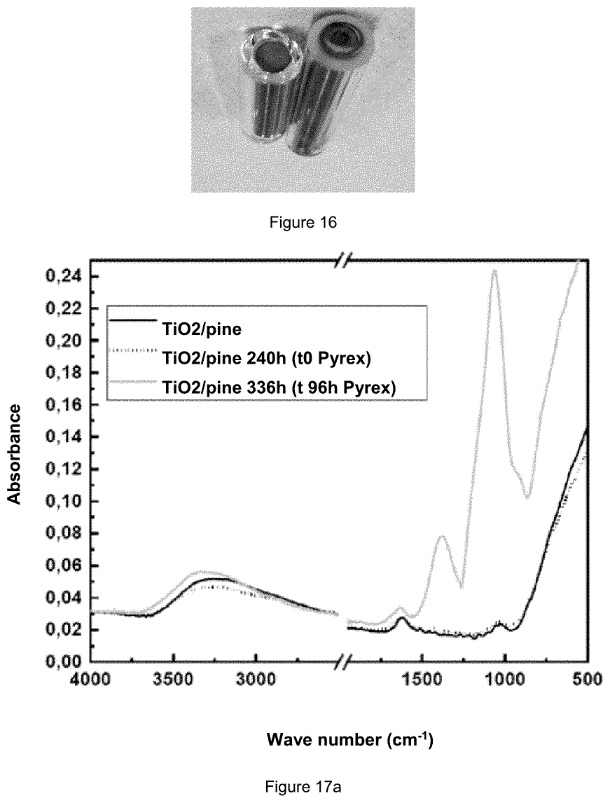

FIG. 16 is a photograph, representing a new Pyrex stir bar (left of the image), and a Pyrex stir bar in the presence of degradation of the TiO₂/pine carrier (right of the image);

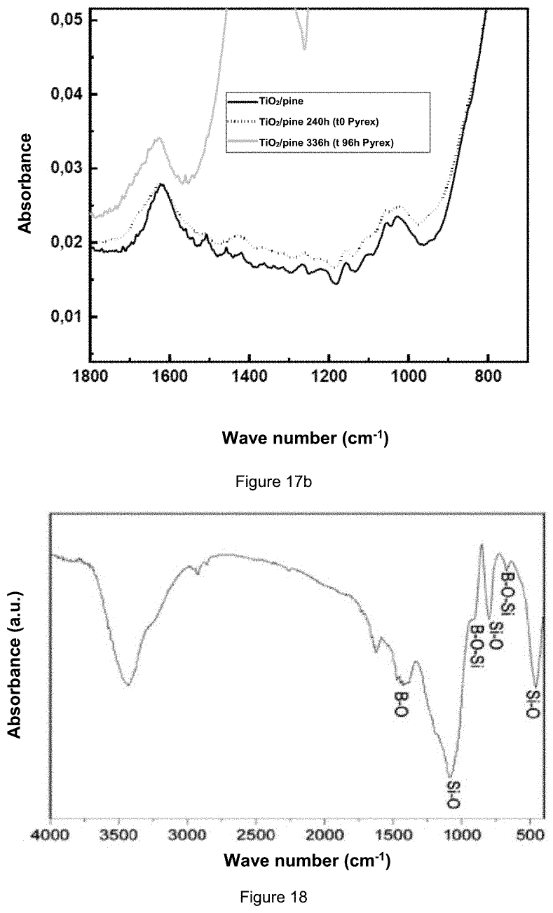

FIGS. 17a and 17b show the monitoring of the degradation of the pine in the TiO₂/pine carrier by following the variations in absorbance, degradation of the Pyrex glass (borosilicate) after 96 hrs;

FIG. 18 represents the characteristic absorbance of borosilicate;

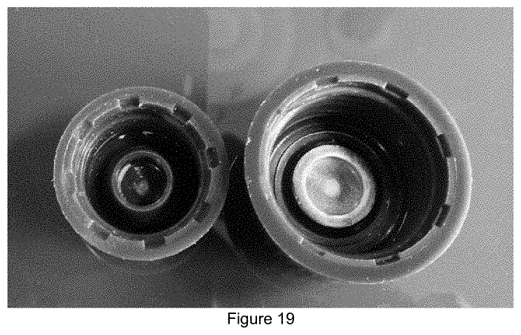

FIG. 19 is a photograph that represents a new polypropylene stopper (left) and a polypropylene stopper after having been in contact with splashed algae degradation solution from a TiO₂/algae carrier (right of image);

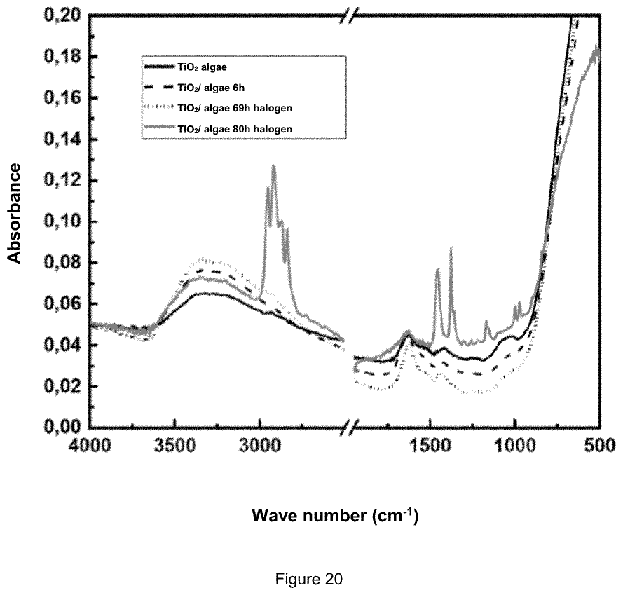

FIG. 20 shows the monitoring of the degradation of the algae in the TiO₂/algae carrier by following the variations in absorbance, degradation of the polypropylene after 80 hrs;

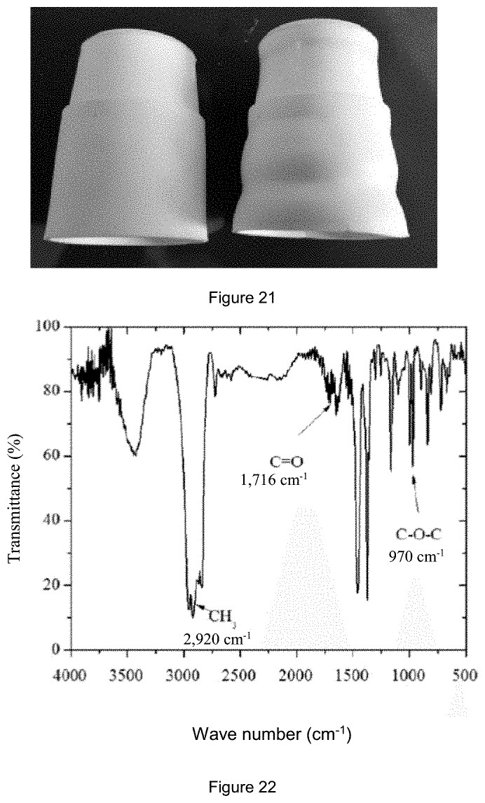

FIG. 21 is a photograph that represents a new septum (left) and a septum after being placed in a pine degradation of a TiO₂/pin carrier (right of the image);

FIG. 22 represents the characteristic FTIR spectrum of polypropylene;

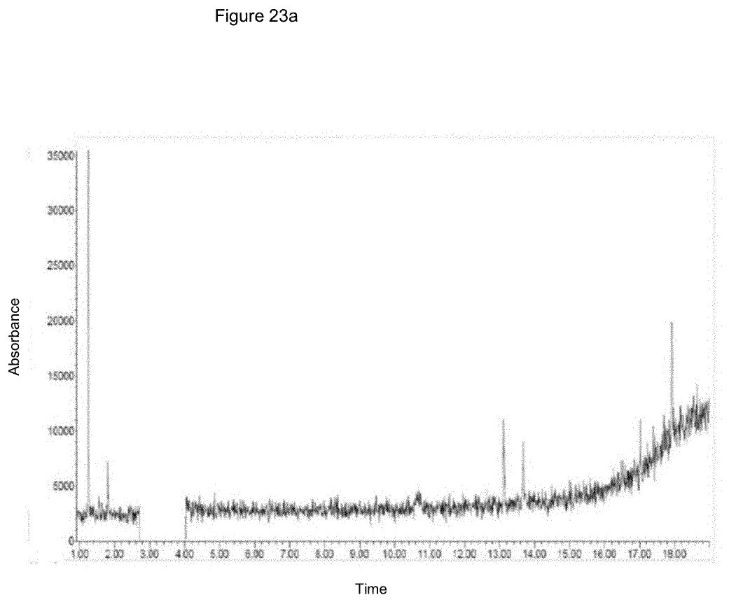

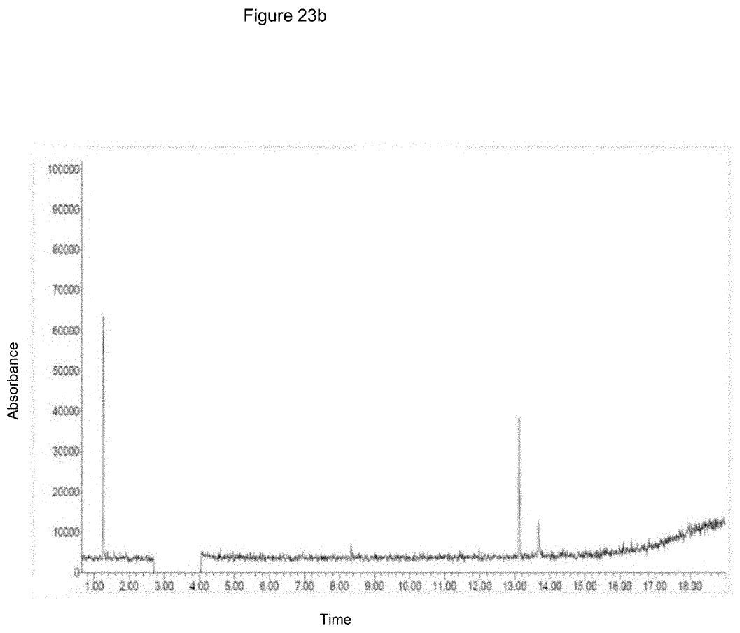

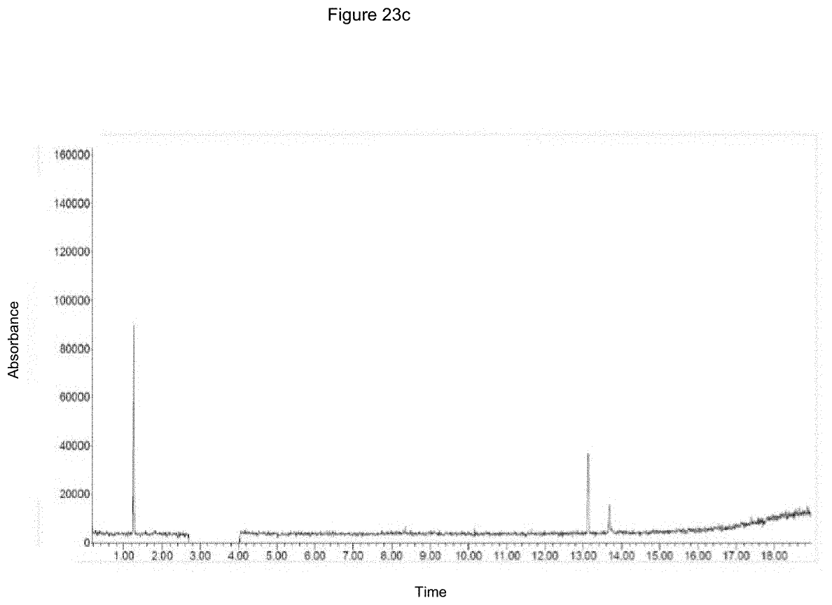

FIGS. 23a, 23b and 23c represent the GC-MS analysis chromatogram of the degradation of 3-fold concentrated pine, algae and pine, respectively;

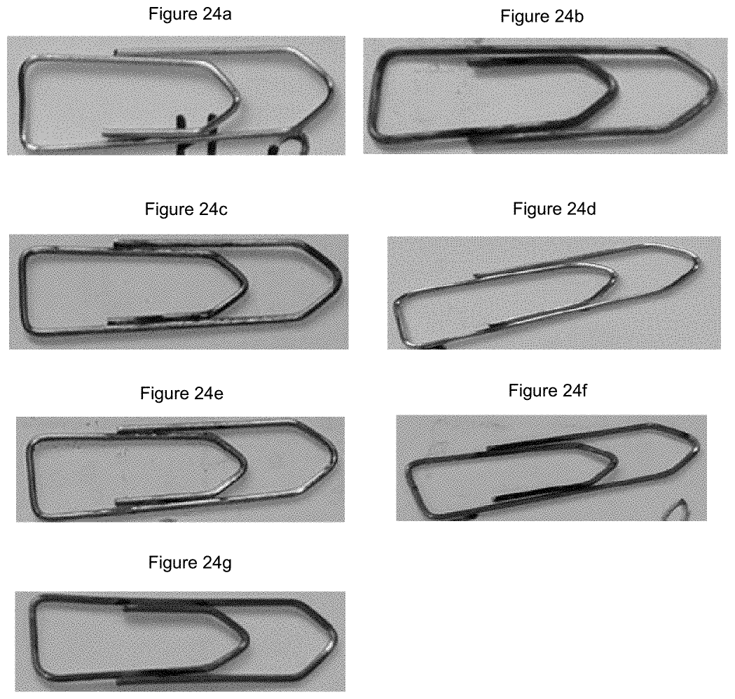

FIGS. 24a to 24g represent images of paperclips placed in aqueous solution (water) for 78 hours by visible light (8,0001 m) with respectively: a) nothing; b) TiO₂/pine; c) TiO₂ of patent EP3393975A1; d) TiO₂ P25 Degussa (Aeroxide); e) TiO₂ P25 Degussa (Aeroxide)+pine; f) TiO₂/algae and g) algae+TiO₂ nanoparticles from a first pine degradation;

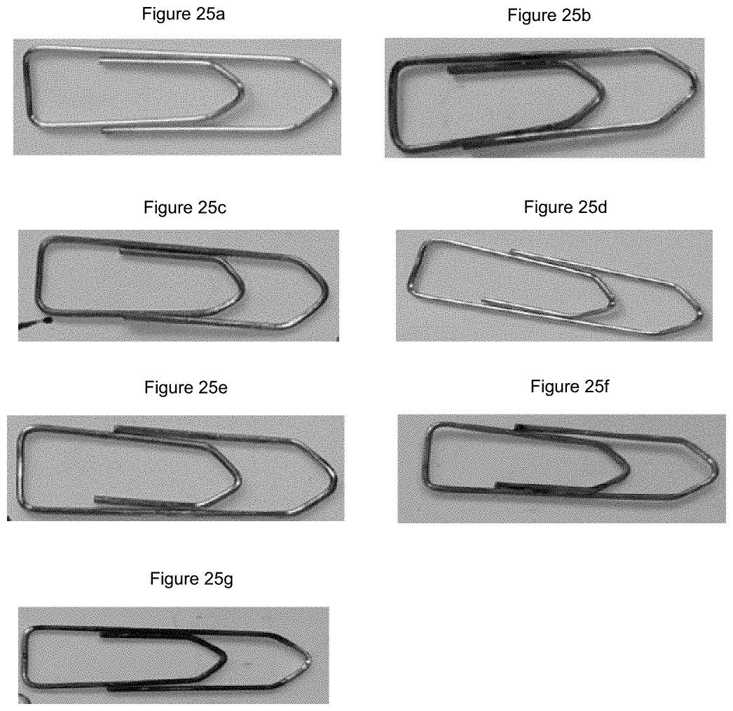

FIGS. 25a to 25g represent images of paperclips placed in aqueous solution (water) for 78 hours in darkness with: a) nothing; b) TiO₂/pine; c) TiO₂ of patent EP3393975A1; d) TiO₂ P25 Degussa (Aeroxide); e) TiO₂ P25 Degussa (Aeroxide)+pine; f) TiO₂/algae and g) algae+TiO₂ nanoparticles from a first pine degradation;

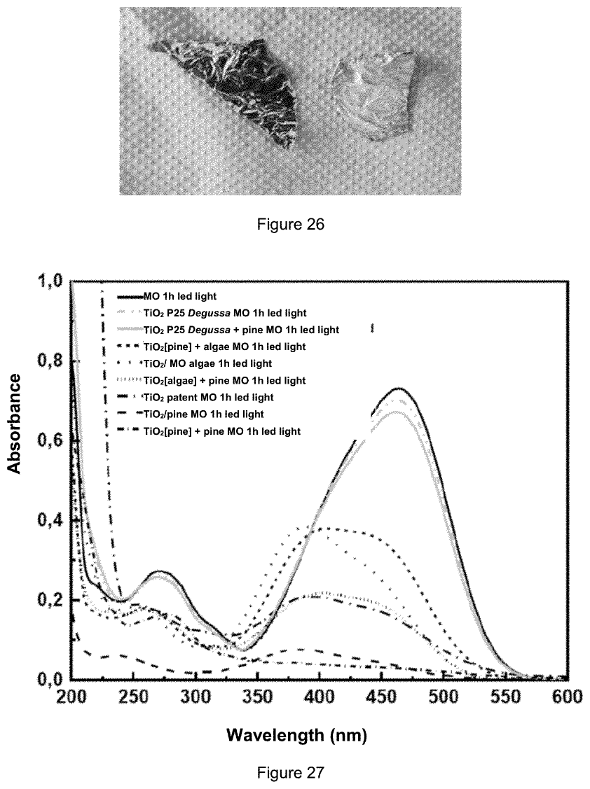

FIG. 26 is a photograph of a comparison between two pieces of aluminum foil immersed in irradiated aqueous solution for 3 days respectively on the left alone and on the right in contact with the TiO₂/pine carrier;

FIG. 27 represents the monitoring of the degradation of a methyl orange solution at 10 ppm by UV-Visible spectrophotometry irradiated for 1 hour by visible light (8,0001 m) in the presence of a TiO₂/biomass carrier and TiO₂ of patent EP3393975A1 and TiO₂ P25 Degussa (Aeroxide);

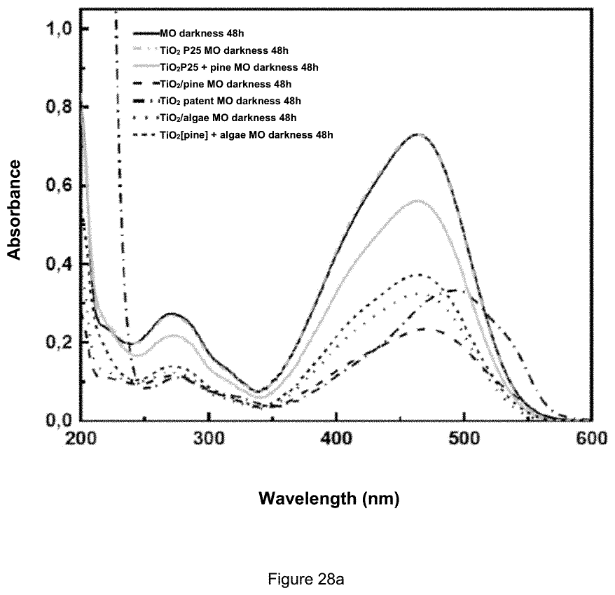

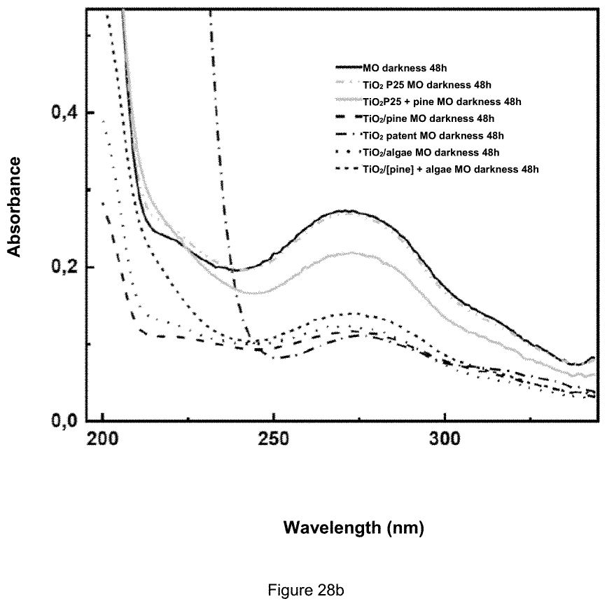

FIGS. 28a and 28b represent the monitoring of the absorption of methyl orange at 10 ppm by UV-Visible spectrophotometry in the dark for 48 hours in the presence of the TiO₂/biomass carrier and TiO₂ of patent EP3393975A1 and TiO₂ P25 Degussa (Aeroxide);

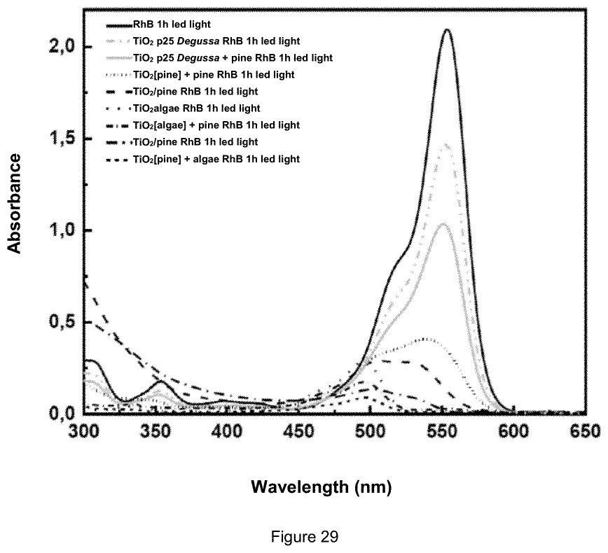

FIG. 29 represents the monitoring of the degradation of a solution of rhodamine b (RhB) at 10 ppm by UV-Visible spectrophotometry irradiated for 1 hour by visible light (8,0001 m) in the presence of TiO₂/biomass carrier and TiO₂ of patent EP3393975A1 and TiO₂ P25 Degussa (Aeroxide);

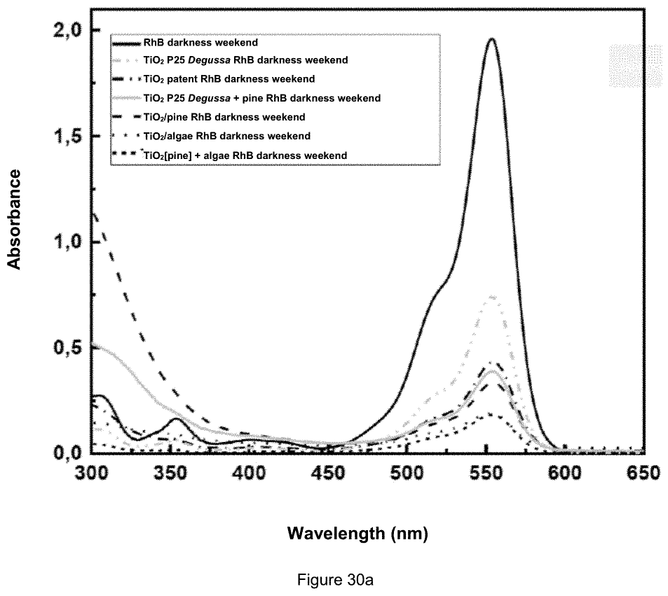

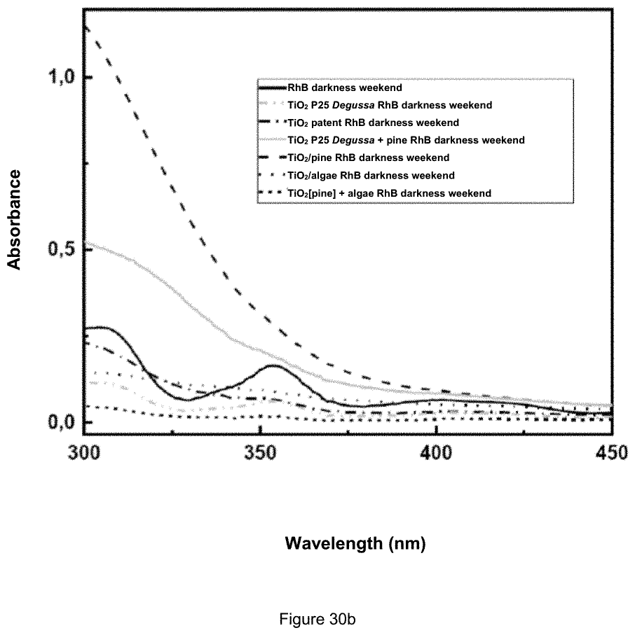

FIGS. 30a and 30b represent the monitoring of the absorption of rhodamine b (RhB) at 10 ppm by UV-Visible spectrophotometry in the dark for 48 hours in the presence of TiO₂/biomass carrier and TiO₂ of patent EP3393975A1 and TiO₂ P25 Degussa (Aeroxide);

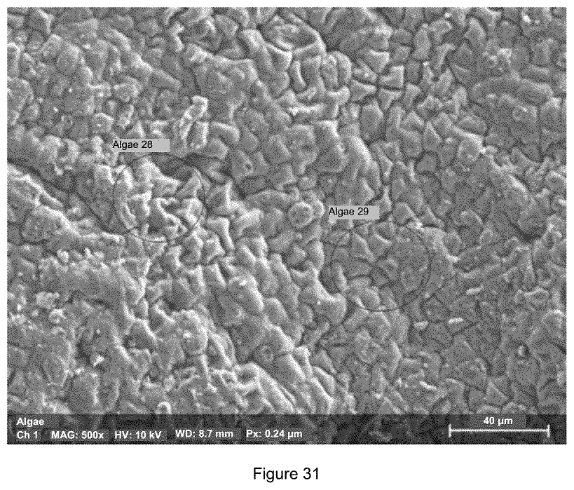

FIG. 31 is an image obtained by scanning electron microscopy of a sample of algae;

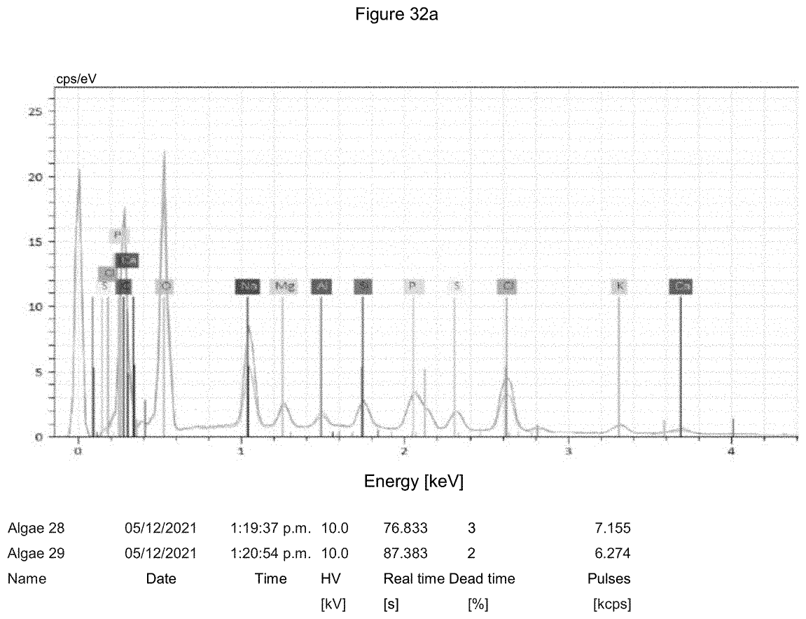

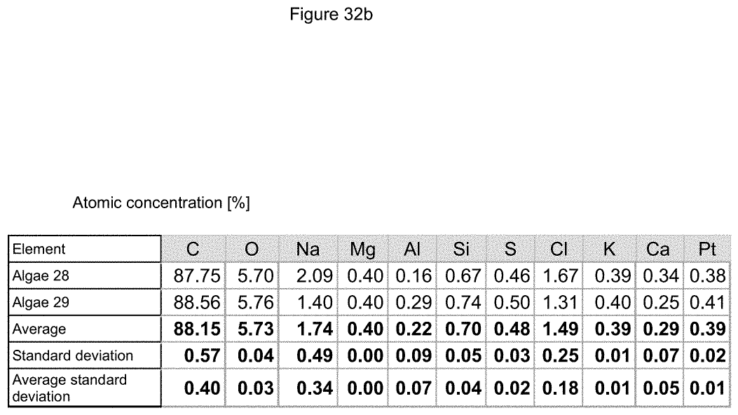

FIGS. 32a and 32b represent the results of EDX analyses of an algae sample.

First, refer to FIG. 1.

In a first step, in an acidic aqueous solution, a titanium precursor is incorporated.

This aqueous solution is, for example, prepared by heating an acidic aqueous solution at a given pH between 0 and 6, at a temperature between 20° C. and 60° C., by adding hydrochloric acid.

In a particular implementation, the aqueous solution is at pH 0, and is formed by the addition of 10 g of 35% hydrochloric acid in 50 mL of water.

The preparation of the aqueous solution is advantageously carried out without the use of a surfactant.

In one implementation, the titanium precursor is 98% titanium isopropoxide (TTIP, tetraisopropyl orthotitanate CAS 546-68-9). Titanium isopropoxide (Ti(O-i-Pr)₄) is a titanium alkoxide.

In other implementations, the titanium precursor is chosen from Na₂Ti₃O₇ sodium titanate or a derivative.

In other implementations, a mixture of titanium precursor and metal oxide is used. Metal oxide is selected from SiO₂, ZrO₂, Al₂O₃, Fe₂O₃, CeO₂, MgO, ZnO, NiO, Cu₂O, SnO₂, RuO₂, Bi₂O₃, WO₃, V₂O₅, Ag₃IN₄.

In a particular implementation, the incorporation of the titanium precursor or the mixture of titanium precursor and a metal oxide is carried out at 50° C., under stirring.

Preferably, the stirring is strong, for example, magnetic stirring of the order of 800 rpm.

This stirring dissolves the precipitate that forms instantly.

Depending on the pH of the acid solution, the TiO₂ obtained is essentially in the form of brookite (when the pH is close to 5), or rutile (when the pH is chosen around 0-2).

In a particular implementation, the metal oxide is WO₃, and the pH of the reaction medium being between 0 and 5, the TiO₂ obtained is mainly in an anatase form.

Upon total dissolution of the precipitate that forms instantly, a biomass product (biomass carrier) is added.

For example, 300 mg of biomass are added to the acidic aqueous solution formed by adding 10 g of 35% hydrochloric acid in 50 mL of water, and containing the titanium precursor and possibly metal oxide.

Biomass is organic matter of plant (including microalgae), animal, bacterial or fungal (fungi) origin, which can be used as a source of energy (bioenergy).

It can be worked, crushed, etc., to be used as a carrier.

In one implementation, the biomass carrier is chosen from the group comprising glucose, sorbitol, monocrystalline cellulose.

In another implementation, the biomass carrier is crushed pine, an algae.

Advantageously, biomass is not charcoal.

Stirring then becomes moderate at the onset of a new precipitate.

In one implementation, stirring is performed using a magnetic stirrer at approximately 300 rpm.

For this precursor solution, the temperature is maintained at 50° C. for 24 hours and then increased to 90° C. for 24 hours.

After cooling, the reaction medium is filtered under vacuum and then dried in the oven, advantageously between 30 and 60° C.

Vacuum filtration makes it possible to isolate an activated biomass 4 that is advantageously presented in the form of a carrier with TiO₂ nanocrystals, the carrier being at least micrometric or millimetric in size.

Activated biomass 4 can be degraded in two ways.

In a first way, the activated biomass 4 is degraded into gas, by contact with oxygen from the air under visible radiation (for example, performed by a halogen lamp 500 W 8,550 lumens).

In a second way, the activated biomass 4 is dispersed in water 6, at a concentration of about 1 g/L under visible radiation (for example, performed by a halogen lamp 500 W 8,550 lumens).

When the activated biomass 4 is altered, [upon appearance of the degradation compounds] and decrease in their intensity, the residue 7 is immersed in an acidic aqueous solution.

In one implementation, the acidic aqueous solution 8 is obtained by mixing 10 g of HCl 35% in 50 mL of water, at 90° C.

Biomass 2 is then incorporated into the reaction medium under vigorous stirring.

For example, 300 mg of biomass 2 are incorporated into the acidic aqueous solution 8 obtained by mixing 10 g of HCl 35% in 50 mL of water, at 90° C.

After 48 hours, the reaction medium is filtered and the solid activated biomass obtained is rinsed with water and then dried in an oven, for example, from 30° C. to 60° C., or between 40° C. and 50° C.

The activated biomass obtained can then undergo photocatalysis as described above (dry or aqueous), the process operating in a cycle.

Now refer to FIG. 2.

The degradation of a dye by photocatalysis, for example, methyl orange or rhodamine B, may create titanium dioxide sensitization, the dye being a conjugate compound. This mechanism is known as a model for photodegradation.

FIG. 2 is a diagram showing changes in methyl orange MO concentration by various reactive biomasses (TiO₂/pine, TiO₂/Al₂O₃/pine) compared to the degradations obtained with commercial titanium dioxide (Aeroxide TiOP25), and the degradations obtained with photocatalysts not supported by biomass (TiO₂/Al₂O₃), photocatalyst binding (TiO₂ or TiO₂/Al₂O₃) to a biomass such as crushed pine increasing the degradation capabilities of methyl orange.

As shown in FIG. 2, the binding of the photocatalyst to a biomass improves the degradation of methyl orange. The results obtained for titanium dioxide bound to crushed pine are higher than those obtained with unbound titanium dioxide, or commercial titanium dioxide. The results obtained for the TiO₂/Al₂O₃photocatalyst bound to crushed pine are higher than those obtained with this same photocatalyst unbound to biomass.

FIGS. 3 to 6 represent the results of absorbance measurements during biomass photocatalytic degradation tests, with 40 mg of activated biomass left in the open, under natural radiation.

FIG. 7, 7-1, 7-2, 7-3 represent the gas chromatography tracking data with flame ionization detector, during treatment of crushed pine biomass in aqueous solution, concentration of 1 g/L of activated biomass being dissolved and exposed to natural light. Peaks appear: at 2.6 minutes for acetone (see FIG. 7-1); at 3.1 minutes for methanol and at 3.3 minutes for isopropanol (see FIG. 7-2), then decreases in acetone and isopropanol peaks, and other peaks appear: at 10.4 minutes for glyoxal or glycerol (see FIG. 7-3).

FIG. 8 represents the gas chromatography tracking data with flame ionization detector, during treatment of crushed pine activated biomass, the activated biomass carrying recycled titanium dioxide. Comparison of results obtained before exposure to natural light and after 1,100 minutes of exposure to natural light shows the attenuation of typical pine biomass peaks, with recycled titanium dioxide retaining its photocatalytic capabilities.

The process has numerous advantages.

Metal oxides are bound to micro or millimetric surfaces, without the risk of dissemination in the environment and without loss of reactivity.

Metal oxide carriers can undergo degradation by photocatalysis.

Composite materials enable the treatment and recovery of biomass products, such as for example, algae, wastewater treatment plant sludge.

The process enables the production of usable decomposition products such as alcohol (isopropanol, methanol, ethanol, glycerol) or others (acetone, acetic acid, etc.) or biogas (hydrogen, methane, syngas).

The process uses natural light, visible light, and UV light.

Advantageously, the degradation process works in the dark.

The process is integrated in situ, all process steps can be performed at a single site.

The process does not use solvent and the working temperatures are moderate.

In another aspect of the invention, a biomass carrier is photocatalysis-active at least in visible light, by bonding of the nanoparticles from the degradation process.

Advantageously, the carrier is a biomass of a different nature than the biomass used during the degradation process.

Advantageously, the first biomass used during the degradation process is pine or algae, and the second biomass used is algae or pine, respectively.

The invention proposes, according to another aspect, a process of degradation of a solid element with one of the carriers described in this invention, the process presenting the following steps:
a) preparation of an aqueous solution comprising a biomass carrier with a titanium oxide precursor, or a mixture of a TiO₂ titanium oxide precursor and at least one other precursor of another MₓO_{y} oxide or nanoparticles from a first degradation, to obtain a carrier according to one of the processes described in the present invention;
b) immersion of a solid element to undergo degradation in the solution of step a);
c) radiation or darkening of the solution;
d) degradation of the biomass carrier and solid element.

The solid element can be metal, polymer such as plastic, Teflon etc.

Advantageously, the degradation process for a solid element works in the dark.

As shown in FIG. 15, biomass degradation leads to Teflon degradation (erosion), a supernatant in the solution appears.

As shown in FIGS. 17a and 17b, biomass degradation leads to Pyrex glass degradation.

As shown in FIG. 19, biomass degradation leads to degradation of the cap coating, i.e. of the polypropylene.

As shown in FIG. 22, the septum degrades after the passage of the TiO₂/biomass carrier (pine and brown algae), as shown in FIGS. 23a, 23b and 23c. The chromatograms show a peak of benzothiazole, this compound is used as an additive in the manufacture of rubbers, the compound is not present in crushed pine or brown algae.

In FIGS. 24, we note very different oxidations: a) the presence of a TiO₂ material that leads to oxidation, b) the addition of biomass in TiO₂/biomass accelerates oxidation, c) synthesized materials superior to commercial material, d) the addition of algae to the TiO₂ [pine] material (pine degraded by photocatalysis a first time) does not decrease oxidation (no loss of reactivity).

In FIGS. 25, two findings are observed:
a) the presence of oxidation (thus reactivity) in the dark;
b) the reactivity is more intense for synthesized materials and even more in the presence of biomass, including by exchanging the type of biomass in the recycling step (TiO₂ [pine]+algae).

In FIG. 26, the bleaching of the surface of the aluminum foil is observed after immersion in an aqueous solution of TiO₂/pine radiated for 48 hours. This phenomenon seems to indicate the presence of oxidized aluminum. Aluminum foil alone in solution has no bleaching.

In FIG. 27, several observations:
a) the commercial material even with biomass has a very low reactivity;
b) reactivity is dependent on the type of biomass used (TiO₂/algae<TiO₂/pine)
c) this specificity of biomasses for the dye is always present in cycle 2 (recycling step)
d) pine provides a better biomass source in TiO₂-based materials for methyl orange degradation.

In FIG. 28, several observations:
a) synthesized materials>commercial material even in the presence of biomass;
b) lower reactivity than light but present (mild shift in the maximum absorbance wavelength, and different spectra below 300 nm);
c) the specificity of the biomasses is always present, including in cycle 2 (recycling step).

In FIG. 29, several observations:
a) commercial material even with biomass has very low reactivity;
b) reactivity is dependent on the type of biomass used, rhodamine B does not degrade in the same way according to TiO₂/algae and TiO₂/pine;
c) This specificity is related to the presence of metal (Mg, Al and Si) in algae;
d) Specificity for the dye still present in cycle 2 (recycling step).

The photodegradation of the elements by reduction or oxidation in the presence of TiO₂ in aqueous solution is known. On the other hand, there is no information in the literature on the degradation of dark elements in the presence of TiO₂ or TiO₂ with a biomass carrier in aqueous solution.

Reactivity in the dark is remarkable for TiO₂ materials with a specific biomass carrier.

In the method of the present invention, the aqueous solution of TiO₂ or TiO₂ with a biomass carrier is prepared in daylight.

During the reaction, the electrons formed by radiation and then trapped on the surface of TiO₂ can continue to react even when the radiation stops. Radiation of TiO₂ nanoparticles (rutile) with 4K UV-Visible light gives weak signals of electrons trapped on the surface of TiO₂; however, after the light was stopped, very strong EPR signals corresponding to the Ti³⁺ cation were observed.

In addition, radicals formed during light exposure may benefit from stabilization due to the presence of biomass. Radical stabilization by steric protection due to the presence of macromolecular systems. These systems are found in biomass either in wood (lignin, cellulose, hemicellulose) or in algae (polysaccharides, chlorophylls, carotenoids, etc.).

1. A preparation process of a TiO₂ photocatalyst/biomass carrier, with TiO₂/MₓO_{y} nanocrystals, of at least nanometric size and photocatalysis active at least in visible light,
comprising the following substeps:
a) preparation and heating of an acidic aqueous solution (1) to a given pH between 0 and 6, and with no surfactant,
b) addition to the aqueous acid solution (1) of a titanium oxide precursor, or a mixture of a TiO₂ titanium oxide precursor and at least one other precursor of another MₓO_{y} oxide, consisting, 80% to 100%, of TiO₂ moles and 0% to 20% of moles of another metal or semi-metal MₓO_{y} oxide, a precipitate then forming, and stirring of the acidic aqueous reaction medium (3) obtained, so as to dissolve the precipitate;
c) immersion of a biomass carrier (2) in the acidic aqueous reaction medium to condense the precursors of the acidic aqueous reaction medium on its surface, which bind to this surface by covalent bonds,
d) heating of the acidic aqueous reaction medium (3) at a temperature between 30° C. and 90° C.,
the biomass carrier (2) for crystallizing the titanium oxide precursors, or the mixture of a titanium oxide precursor and at least one other precursor of the other metal or semi-metal oxide on its surface, the crystallizing precursors, once bound to the biomass surface;
e) recovery of the biomass carrier (4) with TiO₂/MₓO_{y} nanocrystals, bound to the biomass carrier by covalent bonds.

2. The process according to claim 1, wherein the titanium precursor is selected from the group comprising titanium isopropoxide, Na₂Ti₃O₇ sodium titanate or a derivative.

3. The process according to one of claim 1, wherein the metal oxide is selected from the group comprising SiO₂, ZrO₂, Al₂O₃, Fe₂O₃, CeO₂, MgO, CuO, NiO, Cu₂O, SnO₂, RuO₂, Bi₂O₃, WO₃, V₂O₅, Ag₃PO₄.

4. The process according to claim 1, wherein the steps are performed in open air without any organic co-solvent.

5. The process according to claim 1, wherein in step a),
the pH is chosen equal to 5 so as to obtain nanocrystals on the biomass carrier having a stable brookite crystalline form,
or the pH is between 0 and 2 so as to obtain nanocrystals on the biomass carrier having a rutile crystalline form.

6. The process according to claim 1, wherein the first step a) of adding a titanium precursor is performed with the addition of a WO₃ metal oxide, the pH of the reaction medium being between 0 and 5.

7. The process according to claim 1, in the heating step a) of the aqueous solution of hydrochloric acid, the heating temperature is between 20° C. and 60° C.

8. The process according to claim 1, wherein the step of heating d) the acidic aqueous reaction medium comprising the biomass carrier is performed between 30° C. and 100° C.

9. The process according to claim 1, wherein the step of heating d) the acidic aqueous reaction medium (3) comprises heating at a temperature between 30° C. and 60° C. for a given first duration, and heating at a temperature between 50° C. and 90° C. for a given second duration, the first duration being several hours, the second duration being several hours.

10. A photocatalyst biomass carrier (4), which is photocatalysis active at least in visible light and which is at least nanometric in size with TiO₂/MₓO_{y} nanocrystals, bound to its surface by covalent bonds, produced by the method of claim 1, these nanocrystals being composed 80 to 100% of TiO₂ moles and 0 to 20% of other MₓO_{y} metal or semi-metal oxide moles.

11. A biomass carrier with TiO₂/MₓO_{y} nanocrystals according to claim 10, wherein the biomass carrier (2) is selected from the group comprising: glucose, sorbitol, monocrystalline cellulose.

12. A biomass carrier with TiO₂/MₓO_{y} nanocrystals according to claim 10, wherein the biomass carrier (2) is selected from the group comprising algae and wood.

13. The biomass carrier with TiO₂/MₓO_{y} nanocrystals according to claim 9, of micrometric, millimetric, centimetric size or greater.

14. A degradation process of TiO₂ photocatalysts/non-degraded biomass carrier with TiO₂/MₓO_{y} nanocrystals, from a first biomass carrier performed according to claim 9,
said process comprising:
a step f) of photocatalytic degradation at least in visible light, of the first biomass carrier (4) with TiO₂/MₓO_{y} nanocrystals, to obtain a residue (7) and decomposition products;
a step g) of treatment of the residue (7) in an aqueous acidic solution (8), to obtain a recycled photocatalyst solution with TiO₂/MₓO_{y} nanoparticles reactive for the graft, forming a new aqueous acidic reaction medium,
the reactive TiO₂/MₓO_{y} nanoparticles of the residue being created from the first biomass carrier degraded into decomposition products;
a step h) adding a new biomass carrier (2) to the recycled photocatalyst solution;
a step i) heating the new aqueous acidic reaction medium,
a drying step j), to form a new biomass carrier (4) with TiO₂/MₓO_{y} nanoparticles, bound by covalent bond on the surface, the new biomass carrier (4) being photocatalysis active at least in visible light.

15. The degradation process according to claim 14, wherein:
the new biomass carrier (4) with TiO₂/MₓO_{y} nanoparticles, from step j), is degraded during a new step f),
the degradation process of the biomass carrier being performed again in new steps g) to j) to obtain a new biomass carrier (4) with TiO₂/MₓO_{y} nanoparticles from step j),
which is degraded again in another new step f) and so on,
the process operating following a cycle enabling the recovery of the TiO₂/MₓO_{y} nanoparticles from the residue (7) that are reactive for the grafting, and that are bound by covalent bonds to each new biomass carrier (4), added in the acidic aqueous reaction medium (3) containing them.

16. The degradation process according to claim 14, wherein step f) of photocatalytic degradation is performed in natural light or under visible radiation.

17. The degradation process according to claim 14, wherein the photocatalytic degradation step is performed by contact with air oxygen, at atmospheric pressure.

18. The degradation process according to claim 14, wherein the decomposition products are alcohol-type.

19. The degradation process according to claim 14, wherein the decomposition products are selected from the following list: acetone, isopropanol, methanol, glycerol, acetic acid, glyoxal, ethanol.

20. The degradation process according to claim 14, wherein the decomposition products comprise biogases such as hydrogen and/or methane

21. The degradation process according to claim 14, wherein the decomposition products are carried out without agitation of the aqueous solution during step f).

22. A photocatalysis-active biomass carrier at least in visible light, produced by grafting of nanoparticles from the degradation process defined according to claim 14.

23. The carrier according to claim 22, wherein the carrier is a biomass of a different nature than the biomass used during the defined degradation process of claim 14.

24. The carrier according to claim 23, wherein the first biomass used in the degradation process is pine or algae, and the second biomass used is algae or pine respectively.

25. A degradation process of a solid element with a carrier described according to claim 8, presenting the following steps:
a) preparation of an aqueous solution comprising a biomass carrier with a titanium oxide precursor, or a mixture of a TiO₂ titanium oxide precursor and at least one other precursor of another MₓO_{y} oxide or nanoparticles from a first degradation, to obtain a carrier according;
b) immersion of a solid element to undergo degradation in the solution of step a);
c) radiation or darkening of the solution;
d) degradation of the biomass carrier and solid element.
